(19) United States
(12) Patent Application Publication
(10) Pub. No.: US 2005/0190714 A1
(43) Pub. Date: Sep. 1, 2005

(54) System and associated methods for network aware dynamic power management

(75) Inventors: Eugene Gorbatov, Hillsboro, OR (US); Rajesh P. Banginwar, Hillsboro, OR (US)

Correspondence Address: INTEL CORPORATION, P.O. BOX 5326, SANTA CLARA, CA, 95056-5326, US

(73) Assignee: Intel Corporation, Hillsboro, OR (US)

(21) Appl. No.: 11/011,209

(22) Filed: Dec. 13, 2004

Related U.S. Application Data
(60) Provisional application No. 60/548,647, filed on Feb. 28, 2004.

(51) Int. Cl. H04B 7/185

(52) U.S. Cl. 370/318

(57) ABSTRACT

A system and associated methods for network aware, dynamic power management are generally described herein.

### PRIORITY INFORMATION

This non-provisional patent application claims priority to a provisional application of the same title filed Feb. 28, 2004. The provisional application is Application No. 60/548,647, the content of which is expressly incorporated herein for all purposes.

### TECHNICAL FIELD

Embodiments of the invention are generally directed to power management in electronic devices and, more particularly, to a system and associated methods for network aware dynamic power management.

### BACKGROUND

The growth of wireless communications has ushered in a wide range of portable and mobile communications applications. Typically, such applications involve the use of at least one mobile communication device having a depletable power source (e.g., a battery). As can be appreciated, battery powered devices can only be used for a limited period of time before the battery needs to be recharged or replaced. Often, a user will be in a situation where battery recharge or replacement is not possible, and the user will therefore be cut-off from communication.

Addressing this problem in the context of the popular 802.11 WLAN devices, the WLAN standard specifies a Power Save Mode (PSM) in which a mobile device trades network performance for power consumption. In this mode, after transmitting or receiving a packet, a wireless device transitions into a low power (doze) state in which its transceiver is turned off and power consumption is reduced. The device then periodically wakes up to receive beacons sent by an access point (AP). The beacons indicate if any packets were buffered at the AP while the device was in a low power state.

Other techniques for power management are premised on transitioning between a continuous activity mode (e.g., always on) to a PSM-like mode. Yet other conventional techniques rely on information from the applications themselves. This may be fine, if the applications were designed to provide such information, but if not, the power management performance is degraded. The significant degradation in performance associated with the PSM approach, reliance on application support and the processing cost associated with transitioning between different power modes, have limited their deployment/utilization in such devices. Thus, while the PSM and other conventional power management techniques may, in fact, increase battery life, it is often at the cost of application and/or network performance.

### BRIEF DESCRIPTION OF THE DRAWINGS

Embodiments of the present invention are illustrated by way of example, and not by way of limitation, in the figures of the accompanying drawings in which like reference numerals refer to similar elements and in which:

FIG. 1 is a block diagram of an example power management agent, according to one embodiment;

FIG. 2 is a flow chart of an example method for improving power conservation within an electronic device, according to one embodiment of the invention;

FIG. 3 is a flow chart of an example method for modeling latencies, according to one embodiment of the invention;

FIG. 4 is a graphical representation of example transmit/receive latencies associated with various example applications;

FIGS. 5, 6 and 7 provide graphical illustration(s) depicting the performance improvements attained through use of the power management agent, according to one embodiment of the invention;

FIG. 8 is a block diagram of an operating environment within which embodiments of the invention may be implemented, according to one example embodiment; and

FIG. 9 is a block diagram of an example article of manufacture including content which, when executed by an accessing machine, causes the machine to implement one or more aspects of embodiment(s) of the invention.

### DETAILED DESCRIPTION

Embodiments of a system and associated methods for network aware, dynamic power management are generally presented. According to an example embodiment, a power management agent (PMA) is introduced. According to one embodiment, the power management agent may monitor the behavior and/or performance of various applications and coupled network(s). Based, at least in part, on such monitoring the PMA may develop model(s) of future network accesses, which is utilized to modify/implement a power management strategy that reduces (perhaps to a minimal, optimal level) the power consumption of at least a communication subsystem, while limiting (perhaps minimizing) application delay.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

Example Power Management Agent Architecture

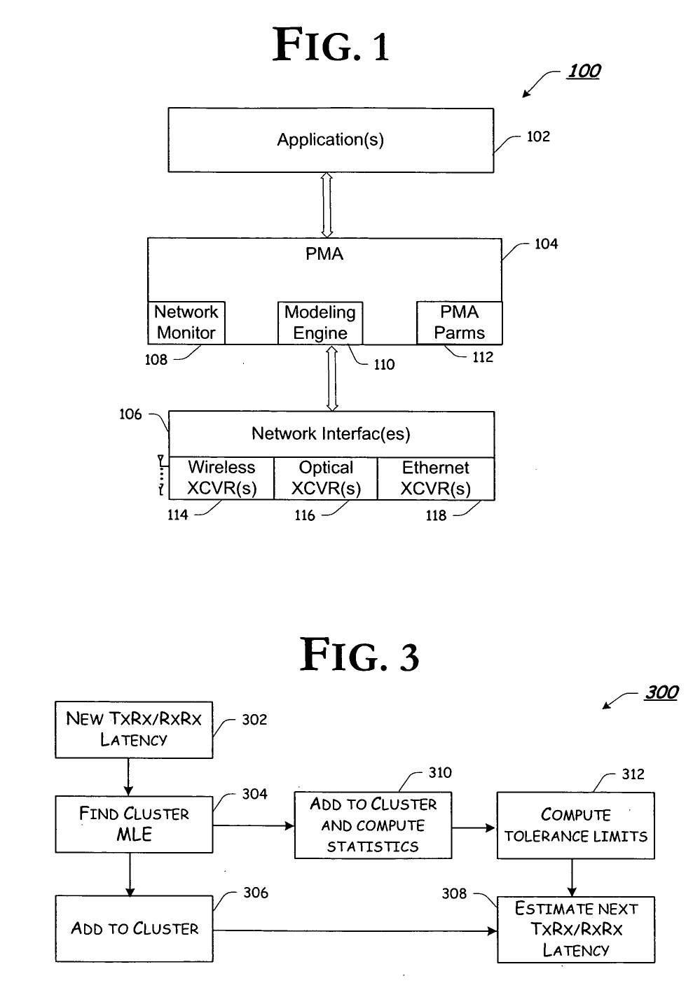

Turning to FIG. 1, a block diagram of an example power management agent (PMA) architecture 104 is depicted, according to one embodiment. For ease of illustration, and not limitation, the PMA 104 is illustrated within the context of an example implementation between one or more applications 102 and network interface(s) 106, although the scope of the invention is not limited in this regard. Embodiments of the PMA 104 may be implemented in hardware, software, firmware or any combination thereof.

In accordance with the illustrated example implementation of FIG. 1, PMA 104 is depicted in association with one or more application(s) 102 selectively utilizing network resources via one or more network interface(s) 106, each logically coupled as shown. As used herein, application(s) 102 are intended to represent any of a wide variety of computing and communication applications known in the art including, but not limited to an email application, a web browser application, peer-to-peer communication and file-sharing applications, and the like.

According to one embodiment, network interface(s) 106 are generally intended to represent any of a wide variety of network interfaces that enable element(s) of an electronic device (e.g., a host device) to communicate with a remote electronic device. According to one example implementation, network interfaces 106 is depicted comprising one or more of a wireless transceiver capability 114, one or more optical transceiver(s) 116 and/or one or more Ethernet transceiver(s) 118, each of which may be regarded as a communication subsystem although the invention is not limited in this regard.

According to one example implementation, PMA 104 addresses the inefficiencies of conventional power management techniques by treating the problem of efficient power management as a combination of two competing goals: reducing the power of the communication subsystems (e.g., 802.11 transceiver), while limiting the latency (actual or perceived) of applications that are utilizing the communication subsystem resources. In this regard, PMA 104 may implement power management techniques on an application-by-application basis and/or on a communication subsystem-by-communication subsystem basis. According to one example embodiment, PMA 104 dynamically transitions select communication subsystem(s) to a low power state only when no network activity is forecast as a result of an innovative modeling technique, described more fully below.

According to one embodiment, PMA 104 is depicted comprising one or more instances of a network monitor feature 108, a modeling engine 110 and one or more power management parameters 112, which enable PMA 104 to selectively implement at least a subset of the network aware dynamic power management features described herein. The operation and effectiveness of PMA 104 is due, at least in part, on its ability to predict network behavior at any given time. According to one embodiment, network behavior may be characterized in view of two factors: the active applications and the current network conditions, although PMA 104 may well consider more than these two factors.

According to one example implementation, PMA 104 may selectively invoke an instance of network monitor 108 to determine which applications are currently accessing the wireless medium and identify network traffic parameters based on the specific network behavior of these applications.

According to one embodiment, the network monitor 108 may quantify network behavior with two or more variables, e.g., transmit/receive (TxRx) latency and/or receive/receive (RxRx) latency, although the scope of the invention is not limited in this regard. Both parameters may be computed by network monitor 108 upon receiving a packet. TxRx latency may be computed when the last access was a transmit event and effectively quantifies the time between the current and last packet. RxRx latency may be computed by network monitor 108 when the last access was a receive event. According to one embodiment, one or more of these latencies is computed by network monitor 108 using information located within the packet (e.g., network address, timestamp, etc.).

PMA 104 may then invoke an instance of the modeling engine 110 to predict future network behavior and/or loading using content provided by the network monitor 108. As developed more fully with reference to FIG. 3, modeling engine 110 utilizes the latency information received from network monitor 108 to compute three parameters: transmit (Tx) timeout, receive (Rx) timeout, and a snooze interval (SI).

Tx timeout describes an amount of time the communication subsystem is to remain in an active (powered) state after transmitting a datagram (e.g., packet, frame, burst, etc.), and may be derived from the TxRx latency determination. The Rx timeout defines the amount of communication subsystem is to remain in an active state after receiving a datagram, and is derived from the RxRx latency determination.

According to one embodiment, the snooze interval (SI) developed by PMA 104 may represent a pattern that the communication subsystem should follow to awaken from a low-power (or, doze) state and receive information from the network infrastructure. According to our example 802.11 wireless LAN embodiment, the SI specifies the interval at which the 802.11 transceiver should follow to receive 802.11 beacons while it is in an idle state. For example, if PMA 104 specifies a snooze interval of {1, 1, 4, 8, 16}, the communication subsystem will awaken to receive the first beacon, then the one after that, then it will skip three beacon (intervals) and awaken to receive the fourth, the eighth and then the sixteenth. By effectively managing the choice of SI pattern and Tx/Rx timeouts can significantly effect application delay and power consumption of an associated communication subsystem. According to one embodiment, one or more of the Tx timeout, Rx timeout and/or the snooze interval comprise power management parameters 112.

It should be appreciated that although introduced in the context of several disparate functional elements 108-112, other embodiments of PMA 104 of greater or lesser complexity are anticipated that implement the features described herein. Thus, when discussing features implemented by specific elements, it should be considered that such discussion is by way of example and ease of illustration, and should not be considered the preferred or only such embodiment.

Example PMA Operation

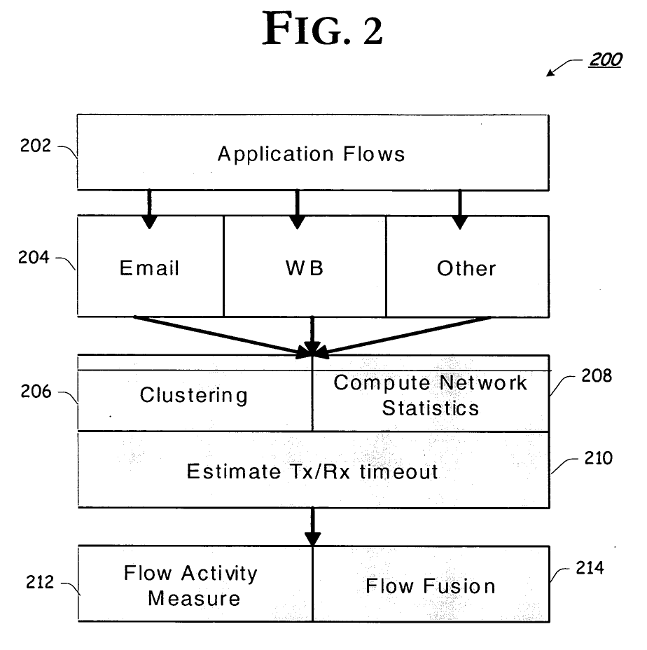

With continued reference to FIG. 1, an example method of power management is provided with reference to FIG. 2, while an example method for modeling future network latencies is provided with reference to FIG. 3, according to but one example embodiment.

Turning to FIG. 2, an architectural flow chart of an example method for network aware dynamic power management is generally introduced according to an embodiment of the invention. One of the features of PMA 104 is that it accounts for the fact that different applications exhibit different network behavior and, as such, PMA 104 dynamically may adopt a power management strategy on an application-by-application basis.

In developing the application-based power management strategy, PMA 104 may invoke an instance of network monitor 108 to analyze and categorize network traffic, block 202. According to one embodiment network monitor 108 may distinguish network traffic based, at least in part, on application type to effectively generate one or more logical application flows, block 204.

In accordance with the illustrated example implementation of FIG. 2, network monitor 108 may categorize the network traffic in accordance with three application flows 204, i.e., one or more associated with each of eMail traffic, web browser (WB) traffic, and cumulatively “other” traffic, although the invention is certainly not limited in this regard. According to one example embodiment, packets are assigned to separate flows 204 by scanning packet headers and identifying protocol parameters that can uniquely classify each packet, although the invention is not limited in this respect. For example, a TCP packet with source or destination port 80 would be recognized by network monitor 108 as being associated with web browser traffic, and would therefore be classified as an element of a WB flow.

For at least a subset of the incoming packets, network monitor 108 may determine the current TxRx and RxRx latency associated with each of the flows in order to predict future TxRx and RxRx latencies. To estimate subsequent flow latencies, PMA 104 may invoke an instance of modeling engine 110, which may cluster (206) the TxRx/RxRx latencies to enable the computation of network statistics (208). An example method for estimating future TxRx/RxRx latencies of blocks 206 and 208 is developed more fully with reference to FIG. 3.

Turning to FIG. 3, a method for predicting application flow latency is provided, according to but one example embodiment. As shown, the method begins with block 302 wherein PMA 104 determines the TxRx and/or RxRx latency, as appropriate, for a received packet associated with a particular flow. If, in accordance with our example 802.11 implementation, the 802.11 communication subsystem (e.g., 114) is in an active, or awake state when a packet is received, network monitor 108 may determine these latencies by subtracting the time between the current and the last network activity.

If, however, the packet is received when the communication subsystem is coming out of a low power (e.g., doze) state, the difference between the last two network accesses may not represent a true TxRx or RxRx latency, as the packet may have spent some time buffered at the remote device (e.g., the AP). In embodiments where it is uncertain how long the packet may have been buffered (e.g., as in an 802.11 implementation), network monitor 108 may approximate the actual latency. According to one embodiment, network monitor 108 may approximate the TxRx and/or RxRx latency by doubling the value of the previous access and taking the maximum between it and the current latency, although the scope of the invention is not limited in this regard. This mechanism allows PMA 104 to gradually adapt to changes in the network behavior without requiring modification to the communication subsystem or the protocols (which may be standardized) associated with such subsystems.

According to one embodiment, PMA 104 may invoke an instance of modeling engine 110 to compute the estimated TxRx and/or RxRx latencies and to generate Tx timeout, Rx timeout and snooze interval value(s) for an associated application flow and communication subsystem. In this regard, modeling engine 110 may use the recent history and the current value of TxRx/RxRx latency to determine the expected latency of the next access for a given application flow. According to one embodiment, modeling engine 110 may segment the sample space into several clusters each exhibiting a more stable distribution of TxRx and RxRx latencies, block 304. According to one embodiment, modeling engine 110 may employ an estimation feature such as, e.g., a maximum likelihood estimation feature to assign the TxRx/RxRx latency to a cluster.

During a warm-up phase (e.g., after (re)initialization of the subsystem, etc.) of PMA 104 the clusters may be static, block 306. However, after collecting one or more initial set(s) of values modeling engine 110 may use the following mechanism to determine new lower and/or upper bound(s) for the cluster \overline{X}±ks, block 310. In the foregoing equation, \overline{X} represents a mean of the Tx/Rx latencies within a given cluster, s is the standard deviation, and k is a tolerance limit for a given number of latency values in the maintained history of the cluster.

Since the number of samples in each cluster can be very large, and their distribution is close to normal, tolerance limits provide a good measure of the range of Tx/Rx latencies that can be expected in the future. According to one embodiment, modeling engine 110 may compute the tolerance limits for a given cluster to ensure 95% confidence for at least 90% of the measurements, block 312, although the invention is not limited in this regard.

Once the cluster(s) have been updated with the recent TxRx/RxRx latency, modeling engine 110 may estimate the next TxRx/RxRx latency, block 314. Since TxRx/RxRx latency exhibits some stability, relying on historical latency values to predict future performance, over at least a short time scale, make the estimations suited for this purpose.

Returning to FIG. 2, once PMA 104 has estimated the TxRx and/or RxRx latency for each of the application flows, it may estimate appropriate Tx/Rx timeout value(s) for one or more of the flow(s), block 210.

In block 212, PMA 104 may identify active application flows and select TxRx/RxRx latency that satisfies their requirements. According to one embodiment, PMA 104 computes an application activity measure for at least a subset of the flows to determine if it is currently active. According to one embodiment, the application activity measure may take into account one or more of application behavior, the time of the last network access, and the density of recent network activity in determining whether the flow should be considered active.

In block 214, PMA 104 may take all active flows and determine a maximum of TxRx and RxRx latencies which get assigned to Tx and Rx timeouts (aka, flow fusion). These timeout values may be applied as system wide parameters that may be subsequently used (e.g., by the 802.11 subsystem 114 within the context of our example 802.11 embodiment) to decide how long to remain awake after accessing the network and before transitioning to a low power state.

After the communication subsystem (e.g., 114) enters a low power state, it uses a novel mechanism of the aforementioned SI pattern to dictate when to wake up for network access (e.g., beacons) and to check if there are any packets waiting at the network (e.g., the AP in the context of the 802.11 embodiment). It should be appreciated that the SI greatly affects both application delay introduced by going into lower power state as well as the power consumption by the effected communication subsystem. In the example 802.11 context, receiving beacons too often limits the benefits of power management, whereas receiving them too infrequently introduces significant delays in application performance, perhaps to the annoyance of an end-user.

According to one embodiment, PMA 104 may select from a number of predetermined SI patterns based, at least in part, on determined network activity and the sensitivity of applications (determined active) to latency in communication flow. According to one embodiment, the selection of the SI pattern is based, at least in part, on any one or more of the computed TxRx/RxRx latencies, the type of applications deemed active, network density, quality of service (QoS) parameters and the like, although the invention is not limited in this regard. In some embodiments, the components of the SI pattern may be dynamically set based on any one or more of the foregoing characteristics.

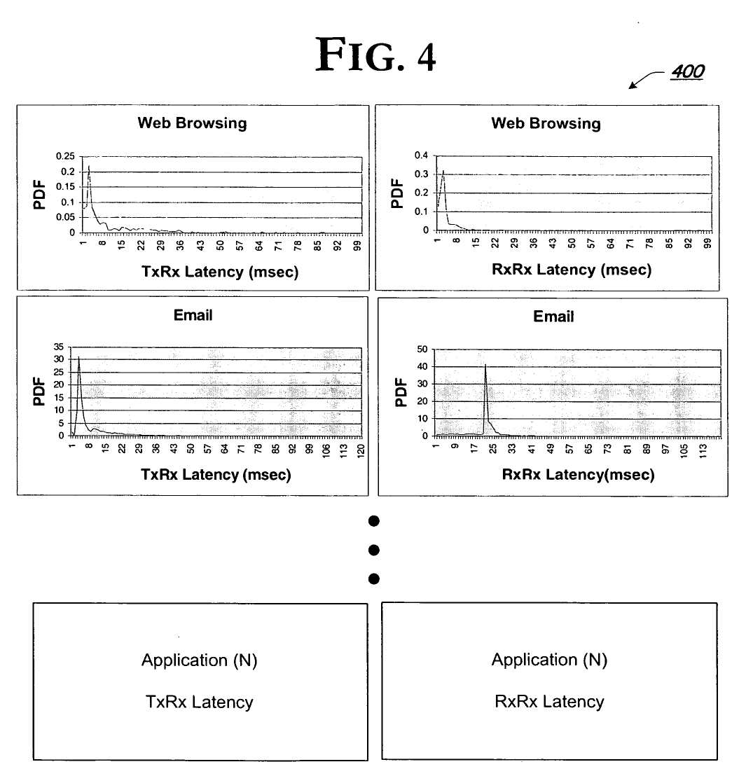

Turning briefly to FIG. 4, a graphical illustration of example application latencies is presented. As shown, FIG. 4 graphically illustrates traces 400 of web browser (WB) and eMail accesses by a large population of users over a period of days. The traces depict TxRx and RxRx latencies that, while heavily tailed, exhibit a large degree of stability with the majority of values concentrated in short intervals. Given a variety of users and tasks they perform on the network, the traces provide a very representative snapshot of network usage for these applications.

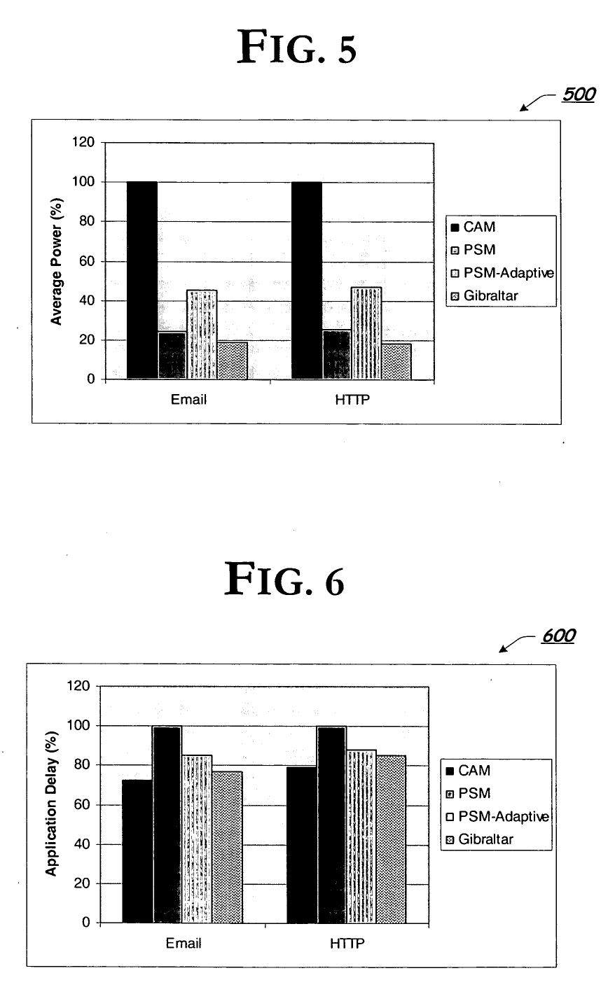

FIGS. 5, 6, and 7 each depict graphical illustrations comparing performance of PMA 104 (aka Gibralter in these figures) against conventional power management techniques. As above, the performance of PMA 104 performance was measured for two classes of applications: eMail and web browsing (WB).

The effectiveness of PMA 104 performance is measured by comparing it to a constant activity power model (CAM), an 802.11 power save mode (PSM) model, and a PSM-adaptive power mode (the so-called Cisco model). The PSM-adaptive algorithm keeps the 802.11 subsystem in PSM and transitions to CAM only when there is a burst of more than two packets waiting at the AP. It then moves back to PSM after 1 sec of no network activity.

FIG. 5 graphically illustrates an average power consumption by a communication subsystem using each of the four techniques introduced above, according to one example embodiment. In particular, FIG. 5 illustrates the performance of each of these power management techniques in reducing power in an 802.11 subsystem. As shown, the PMA-implemented system (aka, Gibraltar) evidenced a 30% savings in power consumption when compared to the PSM technique and over a 50% power reduction of the adaptive PSM technique (which provides better application latency performance than the PSM model). Importantly, PMA 104 provides this power savings without commensurate negative impact on application delay (FIG. 6).

FIG. 6 graphically illustrates the performance of the various power management techniques on application delay, according to one example embodiment. As shown, the delay associated with eMail traffic for a PMA-implementation is about 5% (compared to the CAM embodiment), while the WB delay is limited to less than 8% (when compared to CAM). The results show that PMA 104 effectively adapts to different network conditions and determine power management parameters that yield low power 802.11 operation, while limiting application delay to a minimum.

In this regard, PMA 104 distinguishes itself from the conventional PSM-adaptive algorithm in two ways. First, it applies power management to all network accesses taking a full advantage of low power operation. Second, it limits network delays that result from applying power management algorithm by adapting it to current network conditions and ensuring that the communication subsystem transitions to a low power state only when no network access is expected.

Finally, the effects of PMA 104 and other power management algorithms on the overall system power consumption was quantified by repeating eMail and WB experiments on two representative types of devices: A mobile device like a notebook in which the communication subsystem is responsible for about 10% of the overall power consumption and a handheld device in which the communication subsystem consumes about 40% of the system power.

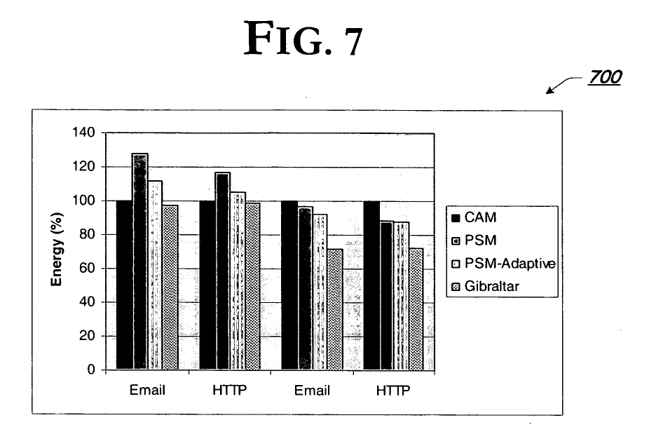

When the base power of the wireless interface is significantly smaller than the system power even a small delay introduced by 802.11 power management may potentially increase the overall system energy when compared to CAM. As can bee seen from FIG. 7, such is the case for a notebook device where both PSM and PSM-adaptive algorithms increase system energy. This increase is due to significant delays introduced by both algorithms, as is evident from FIG. 6 and by a large difference between total platform and wireless subsystem power consumption. In case of a handheld device, PSM and PSM-adaptive are able to reduce system power but their benefit is limited to at most 10%.

In contrast, PMA 104 performs very well on both devices reducing system energy by an average of 30% and 3% for a handheld and notebook device respectively, a significant improvement over conventional PSM and PSM-adaptive (FIG. 7). Again, the performance benefits of PMA 104 evidenced in FIGS. 5-7 are attributable to the dynamic adaptation of power management to application network behavior. Note that rather than bounding the delay, PMA 104 reduces, if not eliminates, the delay and transition to low power doze mode only when it is not expected to degrade application performance. The results in this section show that it is able to do this for both eMail and WB workloads. Note further that energy benefits for a notebook are limited to about 3% as the wireless subsystem consumes a fraction of the total system power in these devices. Nevertheless, it is encouraging that even under these conditions PMA 104 is effective in reducing the communication subsystem power and contributing positively towards saving the overall system energy.

Thus, PMA 104 effectively reduces the communication subsystem power consumption while introducing minimal application delay. As provided above, PMA 104 achieves this result by adapting power management to application specific network behavior and current network conditions. Notably, the introduction of PMA 104 into a system does not require any changes to the communication protocols/specifications associated with the network and are completely transparent to mobile applications and developers.

Example Network Implementation

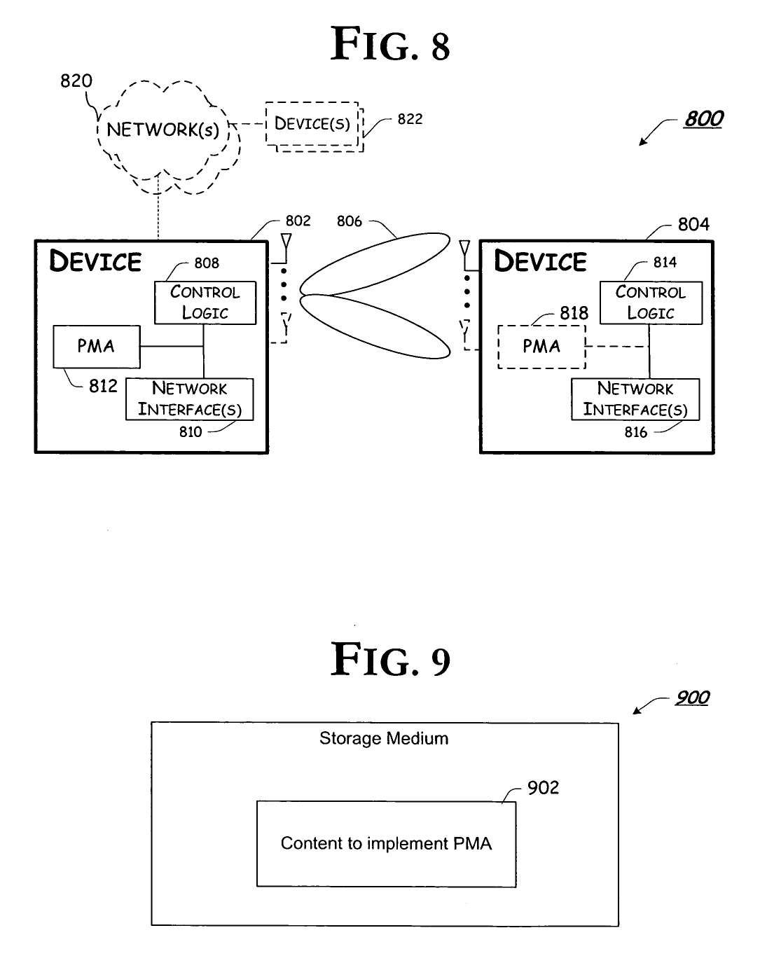

FIG. 8 illustrates a block diagram of an example electronic device 802 with any of a number of network interfaces including, e.g., a wireless network subsystem, to communicate with remote device(s) 804, 822 through any of a number of networks 806, 820 according to various embodiments of the invention. As used herein, devices 802, 804 are intended to represent any of a wide range of computing, consumer or communication electronic devices. In this regard, the communication between devices 802, 804 or 822 may well be performed in accordance with any of a number of wireless or wireline standard and/or non-standard communication protocols. For ease of illustration and not limitation, the broader teachings of the PMA 104 will be described in accordance with an example embodiment 800 of an 802.11x wireless local area network (WLAN) communication environment, although the invention is not to be limited in this regard.

In accordance with the illustrated example embodiment, electronic device 802 is depicted comprising one or more of control logic 808, one or more network interface(s) 810 and a power management agent (PMA) 812, each coupled as shown. According to one embodiment, PMA 812 may well be an instance of PMA 104, although the invention is not so limited. As discussed above, PMA 812 may well be implemented in any one or more of hardware (e.g., DSP, FPGA, etc.), software, firmware or a combination thereof.

In accordance with an example embodiment, network interface(s) 810 may include an 802.11x transceiver coupled with one or more antenna(e) through which device 802 may establish a wireless communication channel 806 with a remote device. As detailed above, PMA 812 may monitor power management related network conditions and develop a model of the expected behavior of future network accesses. PMA 812 may then leverage the developed model to determine when the communication subsystem (e.g., the 802.11 subsystem) may be transitioned to a low power state without impacting application performance, at least as it is perceived by an end-user.

Control logic 808 may control the overall operation of at least electronic device 802. In this regard, control logic 808 is intended to represent any of a broad range of control elements known in the art including, but certainly not limited to, microprocessors, microcontrollers, application specific integrated circuit(s) ASICs with processing cores, field-programmable gate-arrays (FPGAs) and the like, although the invention is not limited in this regard. Control logic 808 may execute one or more instances of one or more applications in support of certain functionality offered by device 802 such as, e.g., voice, data, multimedia communication services and/or power management services such as, e.g., the power management agent. According to one embodiment, control logic 808 may selectively execute one or more instances of an email program, a web browser application, an instant messaging service, a streaming media application, and the like, although the embodiments of the invention are not limited in this regard.

As introduced above, network interface(s) 810 enables device 802 to interface with one or more networks and network types. According to one embodiment, network interface(s) 810 may include one or more of a wireless networking transceiver capability in support of the IEEE 802.11, 802.15, 802.16, 802.18 and/or 802.20 compatible communication, or an infrared transceiver communication capability. Similarly, networking interface(s) 810 may also include one or more of a wireline networking transceiver capability such as, e.g., an Ethernet transceiver, a SONET transceiver, an Optical transceiver, and the like, although the invention is not so limited.

According to one embodiment, the remote device(s) 804, 822 may be similarly enabled with one or more of control logic (814), network interface(s) (816) and even PMA (818) functionality, although the scope of the invention is not limited in this regard. Insofar as implementation of the innovative power management agent (812) within a device (e.g., 802) is transparent to the other elements of the device (e.g., network interface(s) and applications). In this regard, a device (802) enabled with the PMA (812) is forward and/or backward compatible with other devices (804, 822) without requiring modification or upgrade to application software to provide power-management centric messages.

As used herein, network 820 is intended to represent any of a broad range of communication networks including, for example a plain-old telephone system (POTS) communication network; wired and wireless versions of: a local area network (LAN), metropolitan area network (MAN), wide-area network (WAN); a global area network (Internet), a cellular network, and the like. According to one example implementation, device 804 may represent an access point (AP), while device 802 may represent a station (STA), each of which suitable for use within an IEEE 802.1 In wireless local area network (WLAN).

### Alternate Embodiment(s)

FIG. 9 illustrates a block diagram of an example storage medium comprising content which, when invoked, may cause an accessing machine to implement one or more aspects of the power management agent 104 and/or associated methods 200, 300. In this regard, storage medium 900 includes content 902 (e.g., instructions, data, or any combination thereof) which, when executed, causes an accessing appliance to implement one or more aspects of the power management agent 104 described above.

The machine-readable (storage) medium 900 may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem, radio or network connection). As used herein, all of such media is broadly considered storage media.

It should be understood that embodiments of the present invention may be used in a variety of applications. Although the present invention is not limited in this respect, the circuits disclosed herein may be used in many apparatuses such as in the transmitters and receivers of a radio system. Radio systems intended to be included within the scope of the present invention include, by way of example only, wireless local area networks (WLAN) devices and wireless wide area network (WWAN) devices including wireless network interface devices and network interface cards (NICs), base stations, access points (APs), gateways, bridges, hubs, cellular radiotelephone communication systems, satellite communication systems, two-way radio communication systems, one-way pagers, two-way pagers, personal communication systems (PCS), personal computers (PCs), personal digital assistants (PDAs), sensor networks, personal area networks (PANs) and the like, although the scope of the invention is not limited in this respect.

The types of wireless communication systems intended to be within the scope of the present invention include, although not limited to, Wireless Local Area Network (WLAN), Wireless Wide Area Network (WWAN), Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, and the like, although the scope of the invention is not limited in this respect.

Embodiments of the present invention may also be included in integrated circuit blocks referred to as core memory, cache memory, or other types of memory that store electronic instructions to be executed by the microprocessor or store data that may be used in arithmetic operations. In general, an embodiment using multistage domino logic in accordance with the claimed subject matter may provide a benefit to microprocessors, and in particular, may be incorporated into an address decoder for a memory device. Note that the embodiments may be integrated into radio systems or hand-held portable devices, especially when devices depend on reduced power consumption. Thus, laptop computers, cellular radiotelephone communication systems, two-way radio communication systems, one-way pagers, two-way pagers, personal communication systems (PCS), personal digital assistants (PDA's), cameras and other products are intended to be included within the scope of the present invention.

The present invention includes various operations. The operations of the present invention may be performed by hardware components, or may be embodied in machine-executable content (e.g., instructions), which may be used to cause a general-purpose or special-purpose processor or logic circuits programmed with the instructions to perform the operations. Alternatively, the operations may be performed by a combination of hardware and software. Moreover, although the invention has been described in the context of a computing appliance, those skilled in the art will appreciate that such functionality may well be embodied in any of number of alternate embodiments such as, for example, integrated within a communication appliance (e.g., a cellular telephone).

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. Any number of variations of the inventive concept are anticipated within the scope and spirit of the present invention. In this regard, the particular illustrated example embodiments are not provided to limit the invention but merely to illustrate it. Thus, the scope of the present invention is not to be determined by the specific examples provided above but only by the plain language of the following claims.

1. A method of reducing power consumption within an electronic device comprising:
monitoring one or more behaviors of one or more applications executing on an electronic device in combination with network performance related thereto; and
dynamically adjusting one or more parameters of a power management strategy to reduce power consumption of a communication subsystem associated with at least a subset of the one or more executing applications while substantially simultaneously limiting communication latency for at least a subset of the executing applications.

2. A method according to claim 1, the element of monitoring comprising:
separating network traffic into different application flows; and
determining a flow's current TxRx and RxRx latency upon the receipt of one or more datagrams associated with the flow.

3. A method according to claim 2, wherein the network traffic is separated into different application flows based, at least in part, on information contained within the datagrams comprising the network traffic.

4. A method according to claim 2, the element of dynamically adjusting one or more parameters of a power management strategy comprising:
segmenting TxRx/RxRx latency values into one or more clusters each exhibiting a stable distribution of latencies; and
within each cluster, performing statistical analysis on the cluster to develop tolerance limits, from which a model of expected future TxRx/RxRx latency is predicted.

5. A method according to claim 4, wherein the parameters of the power management strategy include one or more of a transmit timeout value, a receive timeout value and/or a snooze interval value.

6. A method according to claim 5, further comprising:
estimating one or more of transmit timeout and/or receive timeout values based, at least in part, on expected future TxRx/RxRx latency, wherein transmit timeout is a measure of the amount of time a communication subsystem is to remain in an active state after transmitting a datagram, wherein receive timeout is a measure of the amount of time a communication subsystem is to remain in an active state after receiving a datagram, and the snooze interval is a pattern denoting the frequency at which a communication subsystem is to awaken from an inactive state to an active state to monitor the network for traffic bound for a host electronic device.

7. A method according to claim 6, wherein adjusting one or more power management parameters further includes:
determining which application flows are currently active; and
updating one or more of the transmit timeout, receive timeout and snooze interval value(s) based, at least in part, on the determination of flow activity and expected flow latency.

8. A storage medium comprising content which, when executed by an accessing device, causes the device to implement a method according to claim 1.

9. An electronic device comprising:
a communication subsystem through which the electronic device can establish communications with a remote device; and
a power management agent, coupled with the communication subsystem, to monitor one or more behaviors of one or more applications executing on an electronic device in combination with network performance related thereto, and to dynamically adjust one or more parameters of a power management strategy to reduce power consumption of a communication subsystem associated with at least a subset of the one or more executing applications while limiting communication latency for at least a subset of the executing applications.

10. An electronic device according to claim 9, the PMA comprising:
a network monitor, to separate network traffic into different application flows, and to determine a flow's current TxRx and RxRx latency upon the receipt of one or more datagrams associated with the flow.

11. An electronic device according to claim 10, wherein the network monitor separates network traffic into different application flows based, at least in part, on information contained within the datagrams comprising the network traffic.

12. An electronic device according to claim 10, the PMA further comprising:
a modeling engine, responsive to the network monitor, to segment TxRx/RxRx latency values into one or more clusters each exhibiting a stable distribution of latencies, and within each cluster, to perform statistical analysis on the cluster to develop tolerance limits, from which a model of expected future TxRx/RxRx latency is predicted.

13. An electronic device according to claim 12, wherein the parameters of the power management strategy include one or more of a transmit timeout value, a receive timeout value and/or a snooze interval value.

14. An electronic device according to claim 13, wherein the modeling engine estimates one or more of transmit timeout and/or receive timeout values based, at least in part, on expected future TxRx/RxRx latency, wherein transmit timeout is a measure of the amount of time a communication subsystem is to remain in an active state after transmitting a datagram, wherein receive timeout is a measure of the amount of time a communication subsystem is to remain in an active state after receiving a datagram, and the snooze interval is a pattern denoting the frequency at which a communication subsystem is to awaken from an inactive state to an active state to monitor the network for traffic bound for a host electronic device.

15. An electronic device according to claim 14, wherein the modeling engine determines which application flows are currently active, and dynamically updates one or more of the transmit timeout, receive timeout and snooze interval value(s) based, at least in part, on the determination of flow activity and expected flow latency.

16. A system comprising:
one or more substantially omnidirectional antenna(e);
a communication subsystem through which the electronic device can establish communications with a remote device; and
a power management agent, coupled with the communication subsystem, to monitor one or more behaviors of one or more applications executing on an electronic device in combination with network performance related thereto, and to dynamically adjust one or more parameters of a power management strategy to reduce power consumption of a communication subsystem associated with at least a subset of the one or more executing applications while limiting communication latency for at least a subset of the executing applications.

17. A system according to claim 16, the PMA comprising:
a network monitor, to separate network traffic into different application flows, and to determine a flow's current TxRx and RxRx latency upon the receipt of one or more datagrams associated with the flow.

18. A system according to claim 17, wherein the network monitor separates network traffic into different application flows based, at least in part, on information contained within the datagrams comprising the network traffic.

19. A system according to claim 17, the PMA further comprising:
a modeling engine, responsive to the network monitor, to segment TxRx/RxRx latency values into one or more clusters each exhibiting a stable distribution of latencies, and within each cluster, to perform statistical analysis on the cluster to develop tolerance limits, from which a model of expected future TxRx/RxRx latency is predicted.

20. A system according to claim 19, wherein the parameters of the power management strategy include one or more of a transmit timeout value, a receive timeout value and/or a snooze interval value.

21. A system according to claim 20, wherein the modeling engine estimates one or more of transmit timeout, receive timeout and snooze interval values based, at least in part, on expected future TxRx/RxRx latency, wherein transmit timeout is a measure of the amount of time a communication subsystem is to remain in an active state after transmitting a datagram, wherein receive timeout is a measure of the amount of time a communication subsystem is to remain in an active state after receiving a datagram, and the snooze interval is a pattern denoting the frequency at which a communication subsystem is to awaken from an inactive state to an active state to monitor the network for traffic bound for a host electronic device.

22. A system according to claim 21, wherein the modeling engine determines which application flows are currently active, and dynamically updates one or more of the transmit timeout, receive timeout and snooze interval value(s) based, at least in part, on the determination of flow activity and expected flow latency.
